(19) United States
(12) Patent Application Publication
(10) Pub. No.: US 2015/0319749 A1
(43) Pub. Date: Nov. 5, 2015

(54) SYSTEM AND METHOD FOR MANAGING NETWORK RESOURCE IMPACT OF MIGRANT WI-FI USERS

(71) Applicant: SANJAY WADHWA, CUPERTINO, CA (US)

(72) Inventor: SANJAY WADHWA, CUPERTINO, CA (US)

(73) Assignee: ALCATEL-LUCENT USA INC., Murray Hill, NJ (US)

(21) Appl. No.: 14/266,086

(22) Filed: Apr. 30, 2014

(51) Int. Cl. H04W 72/04; H04W 12/06

(52) U.S. Cl. CPC H04W 72/048; H04W 12/06; H04W 88/16

(57) ABSTRACT

A method, apparatus and system providing migrant or unauthenticated users associating with a Wi-Fi Access Point (WAP) with a minimal amount of address, data and other managed Wi-Fi network resources until such time as the migrant or unauthenticated users actually authenticate themselves.

### TECHNICAL FIELD

The invention relates generally to managing network resources and, more specifically but not exclusively, to managing network resource impact due to network interaction with migrant users.

### BACKGROUND

Mobile devices (e.g., smart phones, tablet computers and the like) capable of connecting to various Wi-Fi networks (e.g., 802.11x networks and the like) are often configured to communicate with or connect to any Wi-Fi network within range of the mobile device. For example, a smart phone may be configured to initiate a connection based upon the Service Set Identifier (SSID) of every Wi-Fi network access point within range, even if the mobile device will likely move out of range of Wi-Fi access point before completing an authentication process(e.g., before entering credentials via a web portal).

A smart phone carried by an owner walking down the street or traveling by automobile or mass transit may pass within connection range of hundreds or even thousands of Wi-Fi network access points in a short period of time. Each time the smart phone of this “migrant user” tries to connect with a Wi-Fi network access point proximate the user, IP addresses and “subscriber management” resources supporting the Wi-Fi network access point are consumed. While the matter resources consumed by a single migrant user may not be large, consumption of these resources multiplied by many thousands of migrant users interacting with hundreds or thousands of Wi-Fi network access points results in the consumption of significant resources.

For example, a Wireless Local Area Network Gateway (WLAN-GW) is a network element that aggregates and manages Wi-Fi subscribers associated with one or more Wi-Fi network access point. The impact of migrant users upon WLAN-GW operation correspondingly reduces capacity and general resource availability of the WLAN-GW for legitimate, authenticated Wi-Fi users, such as by increasing the amount of time necessary to authenticate legitimate users, decreasing available IP addresses, Network Assigned Translation (NAT) ports, memory and so on. Unfortunately, existing Wi-Fi systems treat all connecting devices as equal since there are no existing techniques for distinguishing migrant Wi-Fi users from legitimate users.

### SUMMARY

Various deficiencies of the prior art are addressed by the present invention of method, apparatus and system providing migrant or unauthenticated users associating with a Wi-Fi Access Point (WAP) with a minimal amount of address, data and other managed Wi-Fi network resources until such time as the migrant or unauthenticated users actually authenticate themselves. In various embodiments, each migrant or unauthenticated user is assigned a common IP address and receives only a limited allocation of data bandwidth and/or other resources until such time as the migrant or unauthenticated user becomes an authenticated user.

A method according to one embodiment for limiting network resource consumption by unauthenticated user devices (UUDs) comprises receiving, by a gateway (GW) associated with a wireless local area network (WLAN), data packets or data frames from one or more UUDs; assigning to each UUD a common internal address with L2 aware Network Assigned Translation (NAT); and forwarding only authentication related traffic associated with any unauthenticated UD.

### BRIEF DESCRIPTION OF THE DRAWING

The teachings of the present invention can be readily understood by considering the following detailed description in conjunction with the accompanying drawings, in which:

FIG. 1 depicts a block diagram of a simplified WiFi system according to one embodiment;

FIG. 2 depicts a flow diagram of a method according to various embodiments; and

FIG. 3 depicts a high-level block diagram of a general purpose computing device suitable for use in various embodiments.

To facilitate understanding, identical reference numerals have been used, where possible, to designate identical elements that are common to the figures.

### DETAILED DESCRIPTION

The invention will be primarily described within the context of a system in which migrant user devices (such as mobile phones, tablet computers and the like) interacting with an open Service Set Identifier (SSID) SSID of a Wi-Fi access point (such as 802.1X and the like) trigger authentication actions at a Wireless Local Area Network Gateway (WLAN-GW). However, those skilled in the art and informed by the teachings herein will realize that the invention is also applicable to any system benefiting from limiting resource consumption attributable to migrant user devices or any other unauthenticated device.

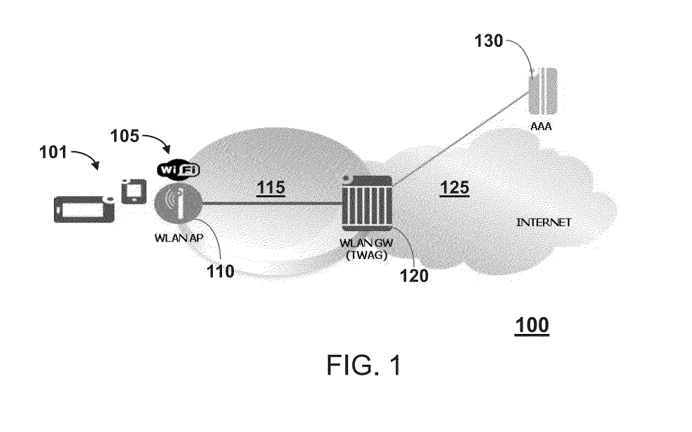

FIG. 1 depicts a high-level block diagram of a wireless access system benefiting from the various embodiments. Specifically, the system 100 of FIG. 1 comprises a Wireless Local Area Network Gateway (WLAN-GW) 120 communicatively coupled to an external/public network such as the Internet 125 and an internal/private network such as an access network 115.

The WLAN-GW 120 is depicted as communicating with a WLAN Access Point (WLAN-AP) 110 via the access network 115. The WLAN-AP 110 comprises, illustratively, a Wi-Fi network 105 access point such as an 802.1X Wi-Fi network access point adapted to communicate with various wireless client devices 101, such as telephony devices (e.g., smart phones and other mobile telephony devices), computing devices (e.g., tablet, laptop and/or desktop computers), consumer electronic devices (e.g., home entertainment systems, televisions and the like), Internet of Things (IOT) devices (e.g., sensors, security systems, home appliances and the like) and so on. While depicted as a 802.1X Wi-Fi network access point, the WLAN-APs 110 may be configured to support different types of wireless and Wi-Fi networks.

The WLAN-GW 120 is depicted as communicating with an Authentication, Authorization and Accounting (AAA) server 130 via the public network 125. The AAA server 130 may comprise, illustratively, a server implementing the Remote Authentication Dial-in User Service (RADIUS) protocol, the DIAMETER protocol or other protocol suitable for implementing the AAA functions.

It will be appreciated that the WLAN-GW 120 will typically be configured to communicate with many WLAN-APs 110 via one or more access networks 115. Further, while depicted as communicating with the AAA server 130 via the public network 125, the WLAN-GW 120 may also be configured to communicate with the AAA server 130 via a control network or other network. In various embodiments, the functions associated with the AAA server 130 may be implemented within or proximate to the WLAN-GW 120.

Generally speaking, the process of establishing a connection between a wireless device and the Internet may comprise associating the wireless device with an access point having an open SSID. An unauthenticated user device (UUD) may then send/receive data via open SSID of the AP. Even if the UUD has no intention of sending or receiving traffic via the open SSID of the AP, various administrative/control functions are invoked in response to such association.

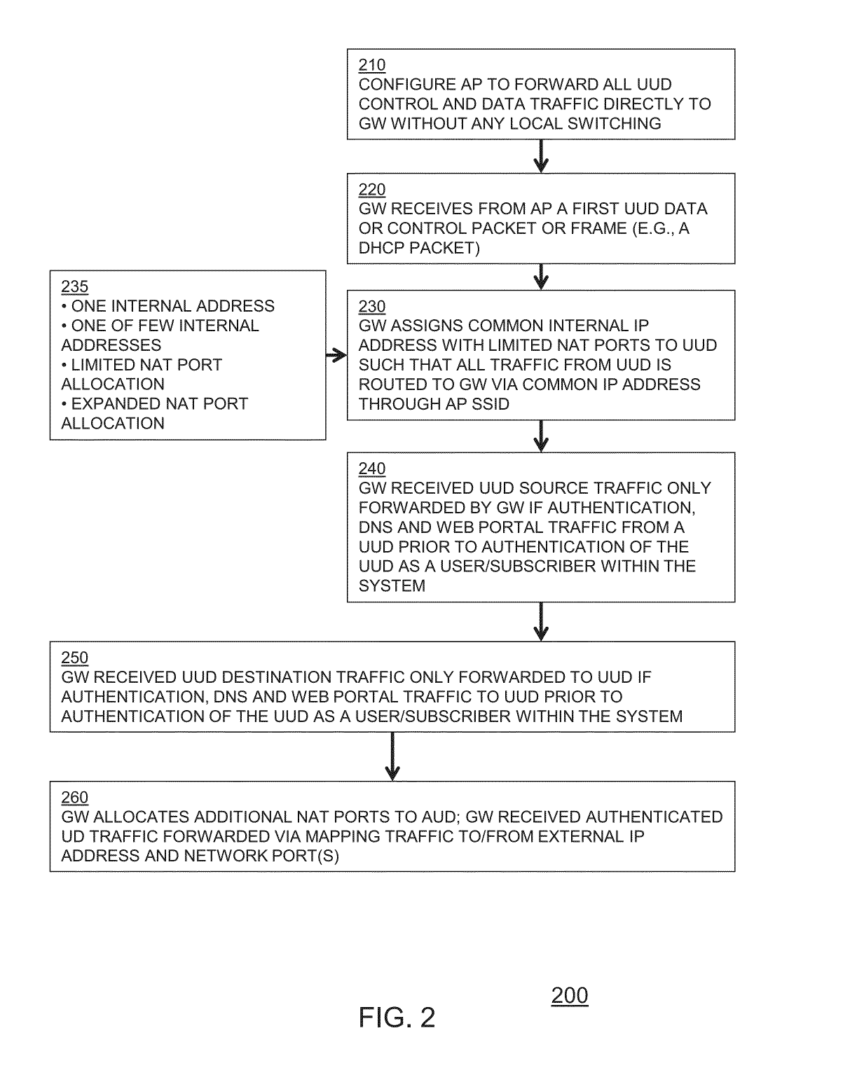

FIG. 2 depicts a flow diagram of a method according to various embodiments. Specifically, the method 200 of FIG. 2 is adapted to facilitate resource-efficient communication with unauthenticated user devices (UUDs) interacting with an open SSID of a wireless network access point (AP). Generally speaking, the method 200 of FIG. 2 provides a mechanism whereby a common internal network IP address is assigned to each UUD along with limited NAT ports to thereby conserve resources. When a UUD becomes an authenticated user device (AUD), additional NAT ports are assigned as appropriate to enable connectivity and other services for the AUD.

At step 210, the AP is configured to forward all UUD control and data traffic directly to a gateway (GW) such as WLAN GW 120 without any local switching of the UUD traffic by the AP (i.e., the AP is configured to operate as a bridge). That is, for any UUD becoming associated with an open SSID of the AP, traffic from that UUD is forwarded directly to the GW without any further processing or local switching by the AP. The AP may be configured via profile or other control information provided to the AP directly or indirectly via the GW, the AAA or some other control entity such as a network manager (not shown).

At step 220, the GW receives a first UUD data or control packet (or frame) from the AP, such as a Dynamic Host Configuration Protocol (DHCP) packet, a data packet, an authentication request or some other message generated by a UUD and routed directly to the GW via the AP associated with the UUD.

At step 230, in response to the DHCP packet or other control packet, the GW assigns a common internal Internet Protocol (IP) address with L2-aware NAT to a limited (restricted) allocation of NAT ports to thereby enable communication between the UUD and the GW. For example, a GW such as WLAN GW 120 assigns to the common internal IP address to an unauthenticated wireless device, such as an unauthenticated client device 101 communicating with WLAN GW 120 via, illustratively, access network 115. Once the UUD has received the common assigned internal IP address, future traffic from the UUD will be routed to the GW via the common assigned internal IP address.

Referring to box 235, the GW may assign one internal address to every UUD or, in various embodiments, one of a small number internal addresses. Further, the GW may allocate a limited number of NAT ports to the internal address for UUD use or, in various embodiments, an expanded number of NAT ports to the internal address for UUD use. The small number of addresses may be assigned in a round robin manner, according to type of user device, according to capability of user device, according to identity of user device and so on.

Generally speaking, each migrant UUD is assigned a common internal IP address and allocated a limited (restricted) allocation of NAT ports configured to support only a subset of UUD communications or service requests; namely, those associated with authentication of the UUD.

In various embodiments, the WLAN GW 120 assigns the same common or internal private IP address with “L2 aware” NAT to all unauthenticated users. In various embodiments, the WLAN GW 120 assigns one of a small number of common or internal private IP addresses with “L2 aware” NAT to each unauthenticated user.

In various embodiments, the subset of UUD communications or service requests supported by the limited NAT port allocation may be expanded to include other types of requests, traffic destinations and the like.

In various embodiments, the limited allocation of NAT ports may be the same for all UDs or may vary depending upon the type of UUD, network capacity/congestion criteria and/or other criteria.

At step 240, UUD sourced traffic received by the GW via the commonly assigned UUD address(es) is only forwarded by the GW if the traffic comprises authorization/authentication traffic, such as Domain Name Service (DNS) traffic, authentication web portal traffic and the like. All other UUD traffic received by the GW is not forwarded (i.e., dropped). Thus, a UUD only receives limited NAT port allocation prior to a corresponding authentication and subscriber creation in the system. In this manner, those resources associated with creating a subscriber within the system and with forwarding traffic from a UUD are conserved.

For example, a GW such WLAN GW 120 may have assigned one common internal address to each of many UUDs, or one of a small number of common addresses to each of the UUDs. Any traffic received via the commonly assigned internal address is only forwarded if that traffic is authentication traffic, DNS traffic or web portal traffic such as for a credential gathering web portal. All traffic received via a non-UUD common address (i.e., traffic from an authenticated user device) is forwarded.

Various embodiments described herein contemplate that each of many unauthenticated user devices are assigned by the GW the same (common) internal/private IP address (or perhaps one of several internal/private IP addresses), which address is mapped to a public IP address and port(s) of the GW via an L2-aware NAT function to provide communications thereby with the external public domain. Thus, the GW may control packet forwarding and the like via the NAT mapping/forwarding tables and other mechanisms.

At step 250, UUD destination traffic received by the GW via an external network facing port is only forwarded to the UUD if the traffic comprises authorization/authentication traffic, such as authentication response traffic received from the AAA 130 or authentication portal via external/public network 125. All other traffic intended for a UUD is not forwarded (i.e., dropped).

At step 260, the GW allocates additional NAT ports to the address of authenticated UDs (AUDs), wherein source traffic is forwarded (e.g., mapped) by the GW to a public IP address and port of the GW via an L2-aware NAT function with an expanded allocation of network ports, while AUD destination traffic is forwarded to the authenticated UD via the common internal IP address associated with the authenticated UD. For example, a GW such WLAN GW 120 may have forwarded authentication related traffic between a UUD and the AAA server 130 at steps 240/250 resulting in authentication and subscriber creation associated with the UD by the AAA server 130.

Thus, in various embodiments the GW allocates an additional number of NAT outside ports to an AUD or address associated with the AUD in response to an indication of that AUD being authenticated by a corresponding WLAN Access Point (WLAN-AP). Such indication may be provided to GW by the WLAN-AP, the AAA or some other entity as an explicit message, data within traffic to/from the AUD and the like.

Generally speaking, the method 200 of FIG. 2 provides a mechanism whereby a common internal network IP address is assigned to each UUD along with a limited NAT port allocation to thereby conserve resources. When a UUD becomes an authenticated user device (AUD), additional NAT ports are allocated to the AUD address as appropriate to enable connectivity and other services for the AUD.

Thus, various embodiments provide that only those resources necessary to support authentication of an unauthenticated user device will be allocated to the unauthenticated user device. All such unauthenticated user devices may be assigned a common IP address such that the pool of IP addresses is not unduly reduced by the signing of individual addresses to unauthenticated user devices. Resources conserved include access point resources, GW resources, AAA resources and so on.

In various embodiments, authentication requests to the AAA server 130 are provided in response to reception of a first data packet from the UUD, rather than in response to a Dynamic Host Configuration Protocol (DHCP) request.

In various embodiments, subscribers are only created within the system after authentication is completed. Subscribers may be created upon reception of RADIUS Change of Authorization (COA) and the like. After creation, a subscriber may be provided with full forwarding services, Service Level Agreement (SLA) management, accounting functions, legal-intercept and the like for Wi-Fi users and so on. Network Address and Port Translation (NAPT) with a higher number of ports or 1:1 NAT may be applied after authentication.

The various steps described above provide an efficient mechanism by which an unauthenticated user device may be associated with a gateway device servicing a wireless network access point. Further, migrant Wi-Fi users which are briefly in proximity to a Wi-Fi access point will only be allowed to interact at a minimum level with the access point and related resources. In addition, subscriber management may be more tightly controlled to ensure appropriate resource utilization.

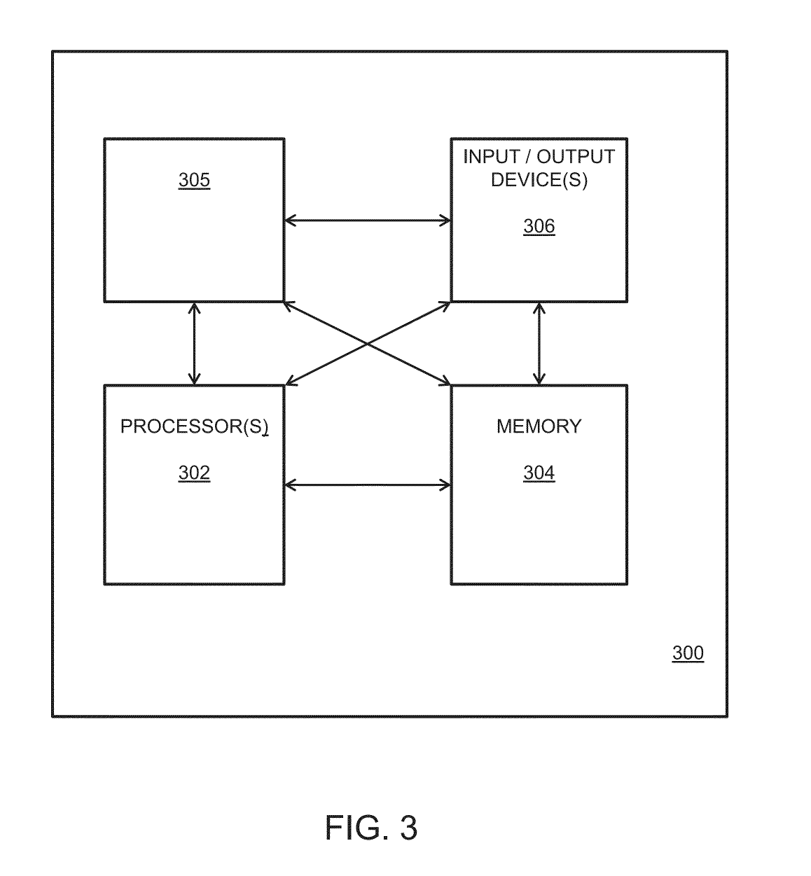

FIG. 3 depicts a high-level block diagram of a computing device, such as a processor in a telecom network element, suitable for use in performing functions described herein such as those associated with the various elements described herein with respect to the figures. The telecom network element may comprise any of the network elements discussed herein, such as the wireless client devices 101, WLAN-AP 110, WLAN-GW 120 and AAA server 130.

As depicted in FIG. 3, computing device 300 includes a processor element 303 (e.g., a central processing unit (CPU) and/or other suitable processor(s)), a memory 304 (e.g., random access memory (RAM), read only memory (ROM), and the like), a cooperating module/process 305, and various input/output devices 306 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 305 can be loaded into memory 304 and executed by processor 303 to implement the functions as discussed herein. Thus, cooperating process 305 (including associated data structures) can be stored on a computer readable storage medium, e.g., RAM memory, magnetic or optical drive or diskette, and the like.

It will be appreciated that computing device 300 depicted in FIG. 3 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method for limiting network resource consumption by unauthenticated user devices (UUDs), the method comprising:
receiving, by a gateway (GW) associated with a wireless local area network (WLAN), data packets or data frames from one or more UUDs;
assigning to each UUD a common internal address with L2 aware Network Assigned Translation (NAT); and
forwarding only authentication related traffic associated with any unauthenticated UD.

2. The method of claim 1, further comprising forwarding toward one or more access points configuration information adapted to cause said one or more access points to forward all UUD traffic directly to the GW.

3. The method of claim 1, wherein said common internal address with L2 aware NAT is assigned to a UUD in response to receiving a DHCP packet from said UUD.

4. The method of claim 1, wherein said common internal address has associated with it a limited NAT port allocation, said limited NAT port allocation configured to support communications associated with authentication of the UUD.

5. The method of claim 1, further comprising allocating to an authorized user device (AUD) a larger number of NAT outside ports.

6. The method of claim 5, wherein said AUD retains the internal IP address assigned to it prior to authentication.

7. The method of claim 1, wherein said common internal address is the same for each UUD.

8. The method of claim 1, wherein said common internal address comprises one of a small number of internal addresses.

9. The method of claim 8, wherein said common internal address is assigned to UUD according to any of round robin selection, type of user device, capability of user device and identity of user device.

10. The method of claim 1, further comprising forwarding all traffic associated with any authenticated UD (AUD).

11. The method of claim 1, wherein said UUDs communicate with said GW via an open Service Set Identifier (SSID) of said access point.

12. The method of claim 1, wherein said authentication related traffic associated with any UUD comprises traffic between said access point and an authentication server.

13. The method of claim 12, wherein said authentication related traffic associated with any UUD comprises a DHCP request.

14. A system providing external network access to authenticated user devices, comprising:
a gateway device disposed between a private network and a public network for routing data there between;
the gateway device configured to communicate with one or more wireless local area network (WLAN) access points via said private network, each access point being configured to operate as a bridge;
the gateway device configured to assign a common internal address with L2 aware NAT to each unauthenticated user device communicating with the gateway device via an access point;
the gateway device configured to forward only authentication related traffic associated with an unauthenticated UD.

15. A gateway (GW) associated with a wireless local area network (WLAN), comprising a processor configured for limiting network resource consumption by unauthenticated user devices (UUDs), comprising:
receiving, by the GW, data packets or data frames from one or more UUDs;
assigning to each UUD a common internal address with L2 aware NAT; and
forwarding only authentication related traffic associated with any unauthenticated UD.

16. The method of claim 15, further comprising forwarding toward one or more access points configuration information adapted to cause said one or more access points to forward all UUD traffic directly to the GW.

17. A tangible and non-transitory computer readable storage medium storing instructions which, when executed by a computer, adapt the operation of the computer to provide a method of limiting network resource consumption by unauthenticated user devices (UUDs) at a gateway (GW) associated with a wireless local area network (WLAN) access point, the method comprising:
receiving, by the GW, data packets or data frames from one or more UUDs;
assigning to each UUD a common internal address with L2 aware NAT; and
forwarding only authentication related traffic associated with any unauthenticated UD.

18. A non-transitory computer program product wherein computer instructions, when executed by a processor in a telecom network element, adapt the operation of the telecom network element to provide a method of limiting network resource consumption by unauthenticated user devices (UUDs) at a gateway (GW) associated with a wireless local area network (WLAN) access point, the method comprising:
receiving, by the GW, data packets or data frames from one or more UUDs;
assigning to each UUD a common internal address with L2 aware NAT; and
forwarding only authentication related traffic associated with any unauthenticated UD.
